(19) United States
(12) Patent Application Publication
(10) Pub. No.: US 2020/0059820 A1
(43) Pub. Date: Feb. 20, 2020

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Ning YANG, Dongguan (CN); Jianhua Liu, Dongguan (CN)

(73) Assignee: GUANGDONG OPPO MOBILE TELECOMMUNICATIONS CORP., LTD., Dongguan (CN)

(21) Appl. No.: 16/661,608

(22) Filed: Oct. 23, 2019

Related U.S. Application Data
(63) Continuation of application No. PCT/CN2017/082228, filed on Apr. 27, 2017.

(51) Int. Cl. H04W 28/02; H04W 72/10; H04W 72/12

(52) U.S. Cl. CPC H04W 28/0278; H04W 72/12; H04W 72/10

(57) ABSTRACT

Embodiments of the present application provide a wireless communication method and device, which can improve the communication performance. The method includes: determining, by a terminal device, data amount of currently buffered uplink data and information about data of a target type in the currently buffered uplink data; transmitting, by the terminal device, a first message to a network device, where the first message is configured to indicate the data amount of the currently buffered uplink data and the information about the data of the target type.

### CROSS-REFERENCE TO RELATED APPLICATIONS

This application is a continuation of the International Application No. PCT/CN2017/082228, filed on Apr. 27, 2017, entitled “WIRELESS COMMUNICATION METHOD AND DEVICE”, the content of which is incorporated herein by reference in its entirety.

### TECHNICAL FIELD

The present application relates to the field of communications and, more particularly, to a wireless communication method and a wireless communication device.

### BACKGROUND

In the existing long term evolution (LTE) system, a user equipment (UE) needs to inform a base station through a buffer status report (BSR) how much data needs to be sent in its uplink buffer, so that the base station determines how many uplink resources should be allocated to the UE.

In the 5th generation communication system (5G), there is a higher requirement for the communication performance.

### SUMMARY

Embodiments of the present application provide a wireless communication method and a wireless communication device.

In a first aspect, a wireless communication method is provided, including:

determining, by a terminal device, data amount of currently buffered uplink data and information about data of a target type in the currently buffered uplink data;

transmitting, by the terminal device, a first message to a network device, where the first message is configured to indicate the data amount of the currently buffered uplink data and the information about the data of the target type.

With reference to the first aspect, in a possible implementation of the first aspect, the information about the data of the target type includes at least one of the following:

information about whether the currently buffered uplink data includes the data of the target type;

data amount of the data of the target type;

a logical channel or a logical channel group in which the data of the target type is located; and

a location of the data of the target type in the logical channel in which the data of the target type is located.

With reference to the first aspect or any preceding possible implementations, in a possible implementation of the first aspect, the data of the target type is data of intra-coded frame type.

With reference to the first aspect, or any preceding possible implementations, in a possible implementation of the first aspect, the first message is a buffer status report.

In an implementation, the buffer status report is a long buffer status report, a short buffer status report, or a truncated buffer status report.

With reference to the first aspect or any preceding possible implementations, in a possible implementation of the first aspect, the information about the data of the target type is configured to indicate that the currently buffered uplink data includes the data of the target type, and indicate the logical channel or the logical channel group in which the data of the target type is located, so that the network device performs a priority scheduling for the logical channel or the logical channel group in which the data of the target type is located.

With reference to a first aspect, or any preceding possible implementations, in a possible implementation of the first aspect, the method further includes:

receiving, by the terminal device, a second message that is transmitted by the network device according to the first message, where the second message is configured to perform a priority scheduling for the terminal device or a priority scheduling for the logical channel or the logical channel group in which the data of the target type is located; and

transmitting, by the terminal device, the currently buffered uplink data according to the second message.

In a second aspect, a wireless communication method is provided, including:

receiving, by a network device, a first message transmitted by a terminal device, where the first message is configured to indicate data amount of currently buffered uplink data in the terminal device and information about data of a target type in the currently buffered uplink data; and

performing, by the network device, a scheduling for the terminal device according to the first message.

With reference to the second aspect, in a possible implementation of the second aspect, the information about the data of the target type includes at least one of the following:

information about whether the currently buffered uplink data includes the data of the target type;

data amount of the data of the target type;

a logical channel or a logical channel group in which the data of the target type is located; and

a location of the data of the target type in the logical channel or the logical channel group in which the data of the target type is located.

With reference to the second aspect or any preceding possible implementations, in a possible implementation of the foregoing aspect, the performing, by the network device, a scheduling for the terminal device according to the first message, includes:

performing a priority scheduling for the terminal device, or for the logical channel or the logical channel group in which the data of the target type is located, when the first message indicating that the currently buffered uplink data includes the data of the target type.

With reference to the second aspect, or any preceding possible implementations, in a possible implementation of the second aspect, the data of the target type is data of intra-coded frame type.

With reference to the second aspect, or any preceding possible implementations, in a possible implementation of the second aspect, the first message is a buffer status report.

In an implementation, the buffer status report is a long buffer status report, a short buffer status report, or a truncated buffer status report.

With reference to the second aspect or any preceding possible implementations, in a possible implementation of the second aspect, the information about the data of the target type is configured to indicate that the currently buffered uplink data includes the data of the target type, and indicate the logical channel or the logical channel group in which the data of the target type is located;

the performing, by the network device, a scheduling for the terminal device according to the first message, includes:

performing, by the network device, a priority scheduling for the logical channel or the logical channel group in which the data of the target type is located according to the first message.

In a third aspect, a terminal device is provided for performing a method according to the first aspect or to any possible implementations of the first aspect. Specifically, the network device includes functional modules for performing the method according to the first aspect or a method according to any possible implementations of the first aspect described above.

In a fourth aspect, a network device is provided for performing a method according to the second aspect or to any possible implementations of the second aspect. Specifically, the network device includes functional modules for performing the method according to the second aspect or a method according to any possible implementation of the second aspect described above.

In a fifth aspect, a terminal device is provided, including a processor, a memory and a transceiver. The processor, the memory and the transceiver communicate with each other and transmit control and/or data signals through an internal connection path, such that the network device performs the method according to the first aspect or a method according to any possible implementations of the first aspect described above.

In a sixth aspect, a network device is provided, including a processor, a memory and a transceiver. The processor, the memory and the transceiver communicate with each other and transmit control and/or data signals through an internal connection path, such that the network device performs the method according to the second aspect or a method according to any possible implementations of the second aspect described above.

In a seventh aspect, a computer readable medium is provided, where the computer readable medium is configured to store a computer program, and the computer program includes instructions for performing a method according to the first aspect or according to any possible implementations of the first aspect described above.

In an eighth aspect, a computer readable medium is provided, where the computer readable medium is configured to store a computer program, and the computer program includes instructions for performing a method according to the second aspect or according to any possible implementations of the second aspect described above.

### BRIEF DESCRIPTION OF THE DRAWINGS

In order to more clearly illustrate the embodiments of the present application, the drawings to be used in the embodiments will be briefly described below. Obviously, the drawings in the following description are only some embodiments of the present invention, and those skilled in the art can obtain other drawings according to these drawings without any creative efforts.

FIG. 1 is a schematic diagram of a wireless communication system according to an embodiment of the present application.

FIG. 2 is a schematic diagram of a format of a long BSR according to an embodiment of the present application.

FIG. 3 is a schematic diagram of a format of a short BSR or truncated BSR according to an embodiment of the present application.

FIG. 4 is a schematic flowchart of a wireless communication method according to an embodiment of the present application.

FIG. 5 is a schematic block diagram of a terminal device according to an embodiment of the present application.

FIG. 6 is a schematic block diagram of a network device according to an embodiment of the present application.

FIG. 7 is a schematic block diagram of a system chip according to an embodiment of the present application.

FIG. 8 is a schematic block diagram of a communication device according to an embodiment of the present application.

### DESCRIPTION OF EMBODIMENTS

The technical solutions in the embodiments of the present application will be described with reference to the attached drawings in the embodiment of the present application. It is obvious that the described embodiments are a part of the embodiments of the present application, and not all of the embodiments. All other embodiments obtained by a person of ordinary skill in the art based on the embodiments of the present application without any creative efforts shall fall within the scope of protection of the present application.

The technical solutions of the embodiment of the present application can be applied to various communication systems, for example, a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an LTE Frequency Division Duplex (FDD) system, an LTE Time Division Duplex (TDD), a Universal Mobile Telecommunication System (UMTS), a Worldwide Interoperability for Microwave Access (WiMAX) communication system, or a future 5G system, etc.

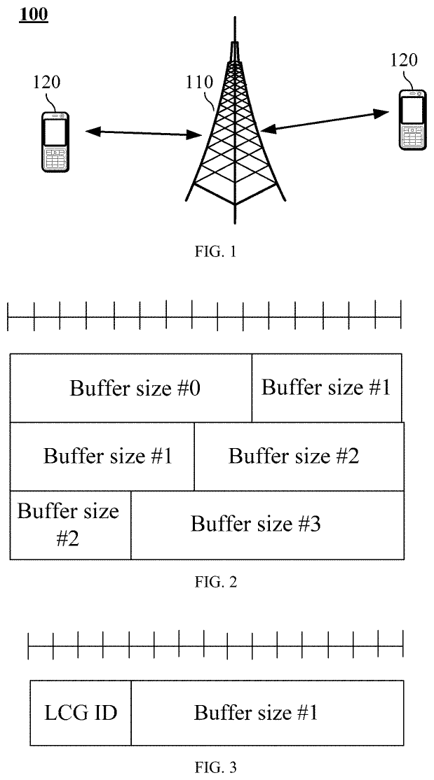

FIG. 1 shows a wireless communication system 100 that is applied to an embodiment of the present application. The wireless communication system 100 may include a network device 110. The network device 100 may be a device that communicates with a terminal device. The network device 100 may provide communication coverage for a particular geographic area and may communicate with terminal devices (e.g., UEs) located within the coverage area. In an implementation, the network device 100 may be a Base Transceiver Station (BTS) in a GSM system or a CDMA system, or may be a NodeB (NB) in a WCDMA system, or may be an Evolutional Node B (eNB or eNodeB) in an LTE system, or a wireless controller in a Cloud Radio Access Network (CRAN), or the network device may be a relay station, an access point, an in-vehicle device, a wearable device, or a network side device in a future 5G network or a network device in a future evolutional Public Land Mobile Network (PLMN).

The wireless communication system 100 also includes at least one terminal device 120 located within the coverage of the network device 110. The terminal device 120 may be mobile or fixed. In an implementation, the terminal device 120 may refer to an access terminal, a user equipment (UE), a subscriber unit, a subscriber station, a mobile station, a mobile platform, a remote station, a remote terminal, a mobile device, a user terminal, a terminal, and a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to wireless modems, an in-vehicle device, a wearable device, a terminal device in the future 5G network, and the like.

In an implementation, device to device (D2D) communication can be performed between terminal devices 120.

In an implementation, the 5G system or network may also be referred to as a New Radio (NR) system or network.

FIG. 1 exemplarily illustrates a network device and two terminal devices. In an implementation, the wireless communication system 100 may include a plurality of network devices and other numbers of terminal devices may be included within the coverage of each network device, which will not be limited by the embodiment of the present application.

In an implementation, the wireless communication system 100 may further include other network entities, such as a network controller, a mobility management entity, which will not be limited by the embodiment of the present application.

It should be understood that terms “system” and “network” herein are used interchangeably. The term “and/or” herein is merely an association describing associated objects, and indicates that there may be three relationships, for example, A and/or B may indicate that A exists separately, both A and B exist, B exists separately. In addition, the character “/” herein generally indicates that the contextual object is in an “or” relationship.

In the wireless communication system shown in FIG. 1, the terminal device may establish a large number of radio bearers (RBs) according to different services, where each radio bearer may correspond to a logical channel.

If a terminal device reports a BSR for each logical channel, it will bring a lot of signaling overhead. To avoid this, a Logical Channel Group (LCG) may be introduced, and each logical channel group may include at least one logical channel. In an implementation, the terminal device may report the BSR based on the logical channel group.

In an implementation, quality of service (QoS) corresponding to a logical channel that is included in each logical channel group is the same or similar.

In an implementation, logical channels established by the terminal device may be divided into four logical channel groups.

In an implementation, the BSR can be reported through a BSR MAC control unit.

When a BSR is reported for a logical channel group, multiple formats may be employed, for example, a long BSR, a short BSR, or a truncated BSR may be used.

Buffer sizes of multiple LCGs can be reported in the long BSR. For example, as shown in FIG. 2, four buffer size domains are included, corresponding to LCG IDs 0-3. Namely, in this format, buffer sizes of all LCGs are reported to the network device.

In a short BSR or a truncated BSR, a buffer size of one LCG can be reported, for example, as shown in FIG. 3.

A short BSR is used when there is only one LCG needs to report a BSR. A truncated BSR can be used when the buffer size of one of the plurality of LCGs needs to be reported, considering the resource issue.

In an implementation, a BSR MAC control unit may correspond to a MAC subheader, where a value in the MAC subheader corresponding to a BSR may have the following corresponding relationship as shown in Table 1 below.

TABLE 1

| Index | LCID Values |
|---|---|
| 00000 | CCCH |
| 00001-01010 | Identity of the logical channel |
| 01011-11000 | Reserved |
| 11001 | Extended Power Headroom Report |
| 11011 | C-RNTI |
| 11100 | Truncated BSR |
| 11101 | Short BSR |
| 11110 | Long BSR |
| 11111 | Padding |

It should be understood that although the foregoing describes that the BSR can be reported by taking a logical channel group as a unit, the embodiment of the present application is not limited thereto. For example, the BSR can also be reported by taking a logical channel as a unit.

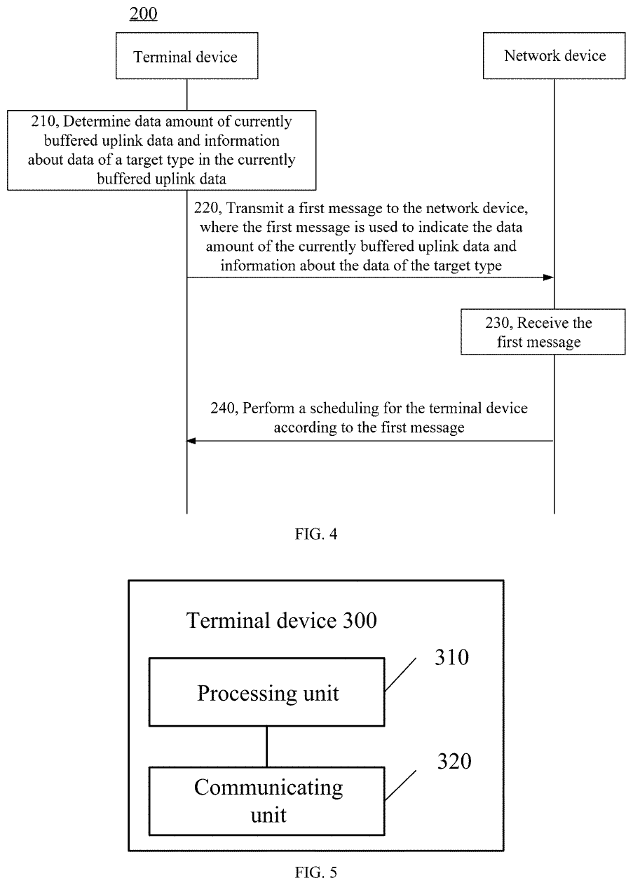

FIG. 4 is a schematic flowchart of a wireless communication method 200 according to an embodiment of the present application. The method 200 may be optionally applied to the system shown in FIG. 1, but is not limited thereto. As shown in FIG. 4, at least part of the contents of the method 200 is as follows.

In 210, a terminal device determines data amount of currently buffered uplink data and information about data of a target type in the currently buffered uplink data.

In an implementation, the information about the data of the target type includes at least one of the following:

1) information about whether the currently buffered uplink data includes the data of the target type, specifically, whether the data of the target type is included may be indicated by a field, for example, the field “1” indicates that the data of the target type is included, and the field “0” indicates that the data of the target type is not included;

2) the data amount of the data of the target type, where the data amount may be the amount of data of the data of the target type in a certain logical channel or a logical channel group;

3) a logical channel or a logical channel group in which the data of the target type is located, where by indicating the logical channel or the logical channel group in which the data of the target type is located, a priority scheduling of the logical channel or logical channel group can be achieved;

4) a location of the data of the target type in the logical channel in which the data of the target type is located, where the location of the data of the target type in the logical channel in which the data of the target type is located may be configured to indicate data amount in the logical channel in which the data of the target type is located before the data of the target type, or be configured to indicate a sum of the data amount in the logical channel in which the data of the target type is located before the data of the target type and the data amount of the data of the target type, or be configured to indicate a resource required to be scheduled for scheduling the data of the target type.

In an implementation, in the encoding process of the media service, there may be three kinds of frames, namely, an intra-coded frame (I-frame), a predictive-frame (P-frame), or a bi-directional interpolated prediction frame (B-frame). The I-frame is a completely encoded frame, the P-frame is a frame generated by taking a previous I-frame as a reference and contains only a code of differential part, and the B-frame is a frame encoded by taking a previous frame and a later frame as references.

The priority of the I-frame is higher than that of the P-frame and that of the B-frame.

The data of the target type in the embodiment of the present application may be data of the type of I-frame.

Of course, the data of the target type in the embodiment of the present application may also be other data types, and the type may be a type of service with higher priority.

In an implementation, the first message is a BSR.

In an implementation, the information about the data of the target type is configured to indicate that the currently buffered uplink data includes the data of the target type, and indicate the logical channel or the logical channel group in which the data of the target type is located, so that the network device performs a priority scheduling for the logical channel or the logical channel group in which the data of the target type is located.

For example, the first message is in a long buffer status report, and the information about the data of the target type is configured to indicate that the currently buffered uplink data includes the data of the target type, and indicate the logical channel or the logical channel group in which the data of the target type is located, so that the network device performs a priority scheduling for the logical channel or the logical channel group in which the data of the target type is located.

For example, the first message is a short buffer status report or a truncated buffer status report, and the information about the data of the target type is configured to indicate that the currently buffered uplink data includes the data of the target type, and indicate the logical channel or the logical channel group in which the data of the target type is located, so that the network device performs a priority scheduling for the logical channel or the logical channel group in which the data of the target type is located.

In an implementation, the information about the data of the target type is configured to indicate that the currently buffered uplink data includes the data of the target type, so that the network device performs a priority scheduling for the terminal device.

For example, the first message is a long buffer status report, and the information about the data of the target type is configured to indicate that the currently buffered uplink data includes the data of the target type, so that the network device performs a priority scheduling for the terminal device.

In 220, the terminal device transmits a first message to the network device, where the first message is configured to indicate the data amount of the currently buffered uplink data and information about the data of the target type.

In 230, the network device receives the first message transmitted by the terminal device.

In 240, the network device performs a scheduling for the terminal device according to the first message.

In an implementation, a priority scheduling is performed for the terminal device, or for the logical channel or the logical channel group in which the data of the target type is located, when the first message indicates that the currently buffered uplink data includes the data of the target type.

In an implementation, the information about the data of the target type is configured to indicate that the currently buffered uplink data includes the data of the target type, and indicate the logical channel or the logical channel group in which the data of the target type is located, and the network device performs a priority scheduling for the logical channel or the logical channel group in which the data of the target type is located.

For example, the first message is a long buffer status report, and the information about the data of the target type is configured to indicate that the currently buffered uplink data includes the data of the target type, and indicate the logical channel or the logical channel group in which the data of the target type is located, and the network device performs a priority scheduling for the logical channel or the logical channel group in which the data of the target type is located.

For example, the first message is a short buffer status report or a truncated buffer status report, and the information about the data of the target type is configured to indicate that the currently buffered uplink data includes the data of the target type, and indicate the logical channel or the logical channel group in which the data of the target type is located, and the network device performs a priority scheduling for the logical channel or the logical channel group in which the data of the target type is located.

In an implementation, the information about the data of the target type is configured to indicate that the currently buffered uplink data includes the data of the target type, and the network device performs a priority scheduling for the terminal device.

For example, the first message is a long buffer status report, and the information about the data of the target type is configured to indicate that the currently buffered uplink data includes the data of the target type, and the network device performs a priority scheduling for the terminal device.

In an implementation, the terminal device receives a second message that is transmitted by the network device according to the first message, where the second message is configured to perform a priority scheduling for the terminal device or a priority scheduling for the logical channel or the logical channel group in which the data of the target type is located; and transmits the currently buffered uplink data according to the second message.

In an implementation, the network device performs a priority scheduling for the logical channel or the logical channel group in which the data of the target type is located may refer to allocating more resources to the logical channel or the logical channel group, or scheduling the logical channel or logical channel group earlier.

In an implementation, the network device performs a priority scheduling for the terminal device may refer to the case that allocating more resources to the terminal device, or scheduling the terminal device earlier. In an implementation, the terminal device may use more resources to transmit the logical channel or the logical channel group in which the data of the target type is located according to resources allocated by the network device, or to transmit the logical channel or the logical channel group earlier.

Therefore, in the embodiment of the present application, a terminal device transmits, to a network device, a first message for indicating the data amount of the currently buffered uplink data and information about the data of the target type; the network device may perform a scheduling for the terminal device according to the information of the data of the target type, and more factors can be taken into account during scheduling, which can improve the communication performance.

FIG. 5 is a schematic block diagram of a terminal device 300 according to an embodiment of the present application. As shown in FIG. 5, the terminal device 300 includes a processing unit 310 and a communicating unit 320; where,

the processing unit 310 is configured to determine data amount of currently buffered uplink data and information about data of a target type in the currently buffered uplink data;

the communicating unit 320 is configured to transmit a first message to a network device, where the first message is configured to indicate the data amount of the currently buffered uplink data and the information about the data of the target type.

In an implementation, the information about the data of the target type includes at least one of the following:

information about whether the currently buffered uplink data includes the data of the target type;

the data amount of the data of the target type;

a logical channel or a logical channel group in which the data of the target type is located; and

a location of the data of the target type in the logical channel in which the data of the target type is located.

In an implementation, the data of the target type is data of intra-coded frame type.

In an implementation, the first message is a buffer status report.

In an implementation, the information about the data of the target type is configured to indicate that the currently buffered uplink data includes the data of the target type, and indicate the logical channel or the logical channel group in which the data of the target type is located, so that the network device performs a priority scheduling for the logical channel or the logical channel group in which the data of the target type is located.

In an implementation, the communicating unit 320 is further configured to:

receive a second message that is transmitted by the network device according to the first message, where the second message is configured to perform a priority scheduling for the terminal device or a priority scheduling for the logical channel or the logical channel group in which the data of the target type is located; and

transmit the currently buffered uplink data according to the second message.

It should be understood that the terminal device can perform corresponding operations performed by the terminal device shown in FIG. 4, which will not be repeated herein for the sake of brevity.

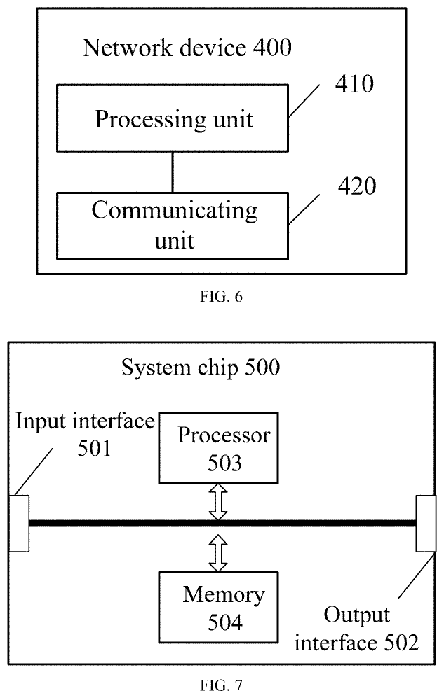

FIG. 6 is a schematic block diagram of a network device 400 according to an embodiment of the present application. As shown in FIG. 6, the network device 400 includes a processing unit 410 and a communicating unit 420; where,

the communicating unit 420 is configured to receive a first message transmitted by a terminal device, where the first message is configured to indicate data amount of the currently buffered uplink data in the terminal device and information about data of a target type in the currently buffered uplink data;

the processing unit 410 is configured to perform a scheduling for the terminal device according to the first message.

In an implementation, the information about the data of the target type includes at least one of the following:

information about whether the currently buffered uplink data includes the data of the target type;

data amount of the data of the target type;

a logical channel or a logical channel group in which the data of the target type is located; and

a location of the data of the target type in the logical channel or the logical channel group in which the data of the target type is located.

In an implementation, the processing unit 410 is further configured to:

perform a priority scheduling for the terminal device, or for the logical channel or the logical channel group in which the data of the target type is located, when the first message indicates that the currently buffered uplink data includes the data of the target type.

In an implementation, the data of the target type is data of intra-coded frame type.

In an implementation, the first message is a buffer status report.

In an implementation, the information about the data of the target type is configured to indicate that the currently buffered uplink data includes the data of the target type, and indicate the logical channel or the logical channel group in which the data of the target type is located;

The processing unit is further configured to:

perform a priority scheduling for the logical channel or the logical channel group in which the data of the target type is located according to the first message.

It should be understood that the network device can perform corresponding operations performed by the network device shown in FIG. 4, which will not be repeated herein for the sake of brevity.

FIG. 7 is a schematic structural diagram of a system chip 500 according to an embodiment of the present application. The system chip 500 of FIG. 7 includes an input interface 501, an output interface 502, a processor 503 and a memory 504 that can be connected with each other through an internal communication connection line. The processor 503 is configured to execute a code in the memory 504.

In an implementation, when the code is executed, the processor 503 implements the method performed by the network device in the method 200 shown in FIG. 4, which will not be repeated herein for the sake of brevity.

In an implementation, when the code is executed, the processor 503 implements the method performed by the terminal device in the method 200 shown in FIG. 4, which will not be repeated herein for the sake of brevity.

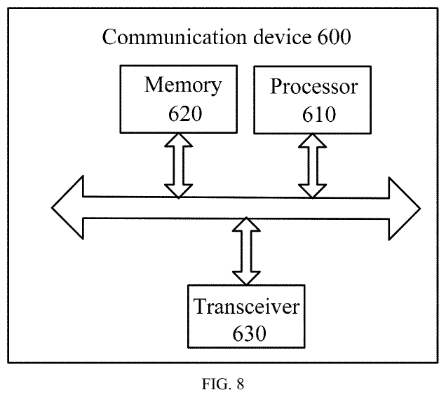

FIG. 8 is a schematic block diagram of a communication device 600 according to an embodiment of the present application. As shown in FIG. 8, the communication device 600 includes a processor 610 and a memory 620. The memory 620 can store a program code, and the processor 610 can execute the program code stored in the memory 620.

In an implementation, as shown in FIG. 8, the communication device 600 may include a transceiver 630, and the processor 610 may control the transceiver 630 to communicate externally.

In an implementation, the processor 610 may call the program code stored in the memory 620 to perform corresponding operations of the network device in the method 200 of FIG. 4, which will not be repeated herein for the sake of brevity.

In an implementation, the processor 610 may call the program code stored in the memory 620 to perform corresponding operations of the terminal device in the method 200 of FIG. 4, which will not be repeated herein for the sake of brevity.

It should be understood that the processor of the embodiment of the present application may be an integrated circuit chip with signal processing capability. In a process of implementation, each step of the foregoing method embodiments may be done by an integrated logic circuit of hardware in a processor or an instruction in a form of software. The processor may be a general purpose processor, a digital signal processor (DSP), an application specific integrated circuit (ASIC), a field programmable gate array (FPGA), a programming logic device, a discrete gate, a transistor logic device, or a discrete hardware component. The methods, steps, and logical block diagrams disclosed in the embodiments of the present application can be implemented or executed. The general purpose processor may be a microprocessor or any conventional processor or the like. The steps of the method disclosed in the embodiments of the present application may be directly implemented by a hardware decoding processor, or may be implemented by a combination of hardware and software modules in the decoding processor. The software module can be located in a conventional storage medium such as a random access memory, a flash memory, a read only memory, a programmable read only memory or an electrically erasable programmable memory, a register, and the like. The storage medium is located in the memory, and the processor reads information in the memory and performs the steps of the above method in conjunction with its hardware.

It is to be understood that the memory in the embodiments of the present application may be a volatile memory or a non-volatile memory, or may include both volatile and non-volatile memory. The non-volatile memory may be a read-only memory (ROM), a programmable ROM (PROM), an erasable PROM (EPROM), or an electrically EPROM (EEPROM) or a flash memory. The volatile memory can be a random access memory (RAM) that acts as an external cache. By way of example and not limitation, many forms of RAM are available, such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM)) and direct rambus RAM (DR RAM). It should be noted that the memory according to the systems and method described herein are intended to include, without being limited to, these and any other suitable types of memory.

Those of ordinary skill in the art will appreciate that elements and algorithm steps of the various examples described in connection with the embodiments disclosed herein can be implemented in electronic hardware or a combination of computer software and electronic hardware. Whether these functions are implemented in hardware or software depends on a specific application and design constraints of the technical scheme. Professionals can use different methods for each specific application to implement the described functionality, but this kind of implementation should not be considered beyond the scope of the present application.

A person skilled in the art can clearly understand that for the convenience and brevity of the description, specific working processes of a system, a device and a unit described above can refer to the corresponding processes in the foregoing method embodiments, and details are not described herein again.

In the several embodiments provided by the present application, it should be understood that the disclosed system, device, and method may be implemented in other manners. For example, the device embodiments described above are merely illustrative. For example, the division of the unit is only a logical function division, in actual implementation, there may be another division manner, for example, multiple units or components may be combined or can be integrated into another system, or some features can be ignored or not executed. In addition, the mutual coupling or direct coupling or communication connection shown or discussed may be an indirect coupling or communication connection through some interfaces, devices or units, and may be electrical, mechanical or otherwise.

The units described as separate components may or may not be physically separated, and the components displayed as units may or may not be physical units, that is, may be located in one site, or may be distributed to multiple network units. Some or all of the units may be selected according to actual needs to achieve the purpose of the solution of the embodiments.

Furthermore, each functional unit in the embodiments of the present application may be integrated into one processing unit, or each unit may be separate physically, or two or more units may be integrated into one unit.

The functions may be stored in a computer readable storage medium if implemented in the form of a software functional unit and sold or used as a standalone product. Based on such understanding, the technical solution of the present application, in nature, or which makes contributions to the prior art, or a part of the technical solution, may be embodied in the form of a software product, which is stored in a storage medium, where a plurality of instructions are included to cause a computer device (which may be a personal computer, a server, or a network device, etc.) to perform all or part of the steps of the method described in the embodiments of the present application. The foregoing storage medium includes: a USB flash disk, a mobile hard disk, a read-only memory (ROM), a random access memory (RAM), a magnetic disk, or an optical disk, and the like which can store program codes.

The foregoing description is only specific embodiments of the present application; however, the scope of protection of the present application is not limited thereto, and changes or substitutions that can be readily think of by any person skilled in the art within the technical scope disclosed in the present application shall be covered by the scope of protection of the present application. Therefore, the scope of protection of the present application shall be subject to the scope of protection of the claims.

What is claimed is:

1. A wireless communication method, comprising:
determining, by a terminal device, data amount of currently buffered uplink data and information about data of a target type in the currently buffered uplink data; and
transmitting, by the terminal device, a first message to a network device, wherein the first message is configured to indicate the data amount of the currently buffered uplink data and the information about the data of the target type.

2. The method of claim 1, wherein the information about the data of the target type comprises at least one of the following:
information about whether the currently buffered uplink data comprises the data of the target type;
data amount of the data of the target type;
a logical channel or a logical channel group in which the data of the target type is located; and
a location of the data of the target type in the logical channel in which the data of the target type is located.

3. The method of claim 1, wherein the data of the target type is data of intra-coded frame type.

4. The method of claim 1, wherein the first message is a buffer status report.

5. The method of claim 4, wherein the buffer status report is a long buffer status report, a short buffer status report, or a truncated buffer status report.

6. The method of claim 1, wherein the information about the data of the target type is configured to indicate that the currently buffered uplink data comprises the data of the target type, and indicate the logical channel or the logical channel group in which the data of the target type is located, enabling the network device to perform a priority scheduling for the logical channel or the logical channel group in which the data of the target type is located.

7. The method of claim 1, wherein the method further comprises:
receiving, by the terminal device, a second message that is transmitted by the network device according to the first message, wherein the second message is configured to perform a priority scheduling for the terminal device or a priority scheduling for the logical channel or the logical channel group in which the data of the target type is located; and
transmitting, by the terminal device, the currently buffered uplink data according to the second message.

8. A terminal device, comprising: a processor, a memory and a transceiver; wherein
the memory stores a program code;
the processor, when executing the program code, is configured to determine data amount of currently buffered uplink data and information about data of a target type in the currently buffered uplink data; and
the processor, when executing the program code, is further configured to control the transceiver to transmit a first message to a network device, wherein the first message is configured to indicate the data amount of the currently buffered uplink data and the information about the data of the target type.

9. The terminal device of claim 8, wherein the information about the data of the target type comprises at least one of the following:
information about whether the currently buffered uplink data comprises the data of the target type;
data amount of the data of the target type;
a logical channel or a logical channel group in which the data of the target type is located; and
a location of the data of the target type in the logical channel in which the data of the target type is located.

10. The terminal device of claim 8, wherein the data of the target type is data of intra-coded frame type.

11. The terminal device of claim 8, wherein the first message is a buffer status report.

12. The terminal device of claim 11, wherein the buffer status report is a long buffer status report, a short buffer status report, or a truncated buffer status report.

13. The terminal device of claim 8, wherein the information about the data of the target type is configured to indicate that the currently buffered uplink data comprises the data of the target type, and indicate the logical channel or the logical channel group in which the data of the target type is located, enabling the network device to perform a priority scheduling for the logical channel or the logical channel group in which the data of the target type is located.

14. The terminal device of claim 8, wherein the processor, when executing the program code, is further configured to control the transceiver to:
receive a second message that is transmitted by the network device according to the first message, wherein the second message is configured to perform a priority scheduling for the terminal device or a priority scheduling for the logical channel or the logical channel group in which the data of the target type is located; and
transmit the currently buffered uplink data according to the second message.

15. A network device, comprising: a processor, a memory and a transceiver; wherein
the memory stores a program code;
the processor, when executing the program code, is configured to control the transceiver to receive a first message transmitted by the terminal device, wherein the first message is configured to indicate data amount of currently buffered uplink data in the terminal device and information about data of a target type in the currently buffered uplink data; and
the processor is further configured to perform a scheduling for the terminal device according to the first message.

16. The network device of claim 15, wherein the information about the data of the target type comprises at least one of the following:
information about whether the currently buffered uplink data comprises the data of the target type;
data amount of the data of the target type;
a logical channel or a logical channel group in which the data of the target type is located; and
a location of the data of the target type at the logical channel or logical channel group in which it is located.

17. The network device of claim 16, wherein the processor is further configured to:
perform a priority scheduling for the terminal device, or for the logical channel or the logical channel group in which the data of the target type is located, when the first message indicates that the currently buffered uplink data comprises the data of the target type.

18. The network device of claim 16, wherein the data of the target type is data of intra-coded frame type.

19. The network device of claim 16, wherein the first message is a buffer status report.

20. The network device of claim 15, wherein the information about the data of the target type is configured to indicate that the currently buffered uplink data comprises the data of the target type, and indicate the logical channel or the logical channel group in which the data of the target type is located; and
the processor is further configured to:
perform a priority scheduling for the logical channel or the logical channel group in which the data of the target type is located according to the first message.
